(19) United States
(12) Patent Application Publication
(10) Pub. No.: US 2008/0013313 A1
(43) Pub. Date: Jan. 17, 2008

(54) Lighting device comprising a plurality of light sources

(76) Inventor: Katrin Schroll, Matzing (DE)

Correspondence Address: FISH & RICHARDSON PC, P.O. BOX 1022, MINNEAPOLIS, MN, 55440-1022, US

(21) Appl. No.: 11/765,905

(22) Filed: Jun. 20, 2007

(30) Foreign Application Priority Data
Jun. 23, 2006 (DE) 10 2006 028 961.7

(51) Int. Cl. F21V 5/02; F21V 9/00

(52) U.S. Cl. 362/231; 362/240

(57) ABSTRACT

A lighting device is described that comprises a plurality of light sources (1a, 1b, 1c, 1d, 1e, 1f), each of which generates a respective ray bundle (3a, 3b) and has a respective collimating optic (2a, 2b, 2c, 2d, 2e, 2f) associated with it, and a collecting optic (4) having an entrance side and an exit side, wherein each collimating optic (2a, 2b, 2c, 2d, 2e, 2f) directs the ray bundle of the respective associated light source (1a, 1b, 1c, 1d, 1e, 1f) to the entrance side of the collecting optic (4) and the ray bundles are collectively extracted through the exit side.

A lighting device comprising a plurality of light sources is disclosed.

LEDs are often employed as light sources in such lighting devices. LEDs are distinguished by high efficiency and long life. Lighting devices for mixed-color, particularly white, light can be implemented with a plurality of different-colored LEDs, the light produced by the respective LEDs being mixed together to yield the desired mixed-color or white light.

The object of the present invention is to disclose a lighting device comprising a plurality of light sources, wherein the light emitted by the individual light sources is blended as evenly as possible.

This object is achieved by means of a lighting device according to Claim 1. Advantageous improvements of the invention are the subject matter of the dependent claims.

According to the invention, provided are a lighting device comprising a plurality of light sources, each of which generates a respective ray bundle and has associated with it a respective collimating optic, and a collecting optic having an entrance side and an exit side, wherein each collimating optic directs the ray bundle of the respective associated light source to the entrance side of the collecting optic and the ray bundles are extracted collectively from the exit side of the collecting optic.

The invention proceeds in this from the idea that advantageously uniform blending of the ray bundles generated by the light sources can be achieved by first collimating the ray bundles by means of the collimating optics and then directing them to a common collecting optic to achieve uniform blending of the ray bundles on the exit side. In addition, optical losses such as reflection and scattering losses can be kept advantageously low in this way.

At least one of the light sources of the lighting device has a main radiation direction associated with it, the ray bundle from this light source being directed by the collimating optic to the entrance side of the collecting optic in a direction oblique to said main radiation direction. Further preferably, each light source has a respective main radiation direction associated with it, the respective ray bundles generated by the light sources being directed by the collimating optic to the entrance side of the collecting optic in a direction oblique to the respective main radiation direction. The collecting optic is therefore disposed acentrally to the collimating optic(s), thus making more space available for the individual light sources when a plurality of light sources is to be arranged, for example, around the collecting optic, and hence from an overall standpoint facilitating the use of plural light sources. It is useful in this case for the light sources and/or the collimating optics to be arranged symmetrically around the collecting optic. Further, the main radiation directions of the light sources can be aligned in parallel with one another.

In a further preferred configuration of the lighting device, the light sources and/or the collimating optics are configured and arranged such that the ray bundles from the individual light sources overlap on the entrance side of the collecting optic. It is desirable in this case for the overlap of the ray bundles on the entrance side to be as complete as possible.

In an advantageous improvement of the lighting device, the light sources are arranged in one plane, while the collimating optics are preferably spaced away from that plane. The plane can be defined, for example, by a circuit board on which the light sources are mounted. Further preferably, the collecting optic has a central axis from which the light sources are similarly spaced apart. The light sources can, for example, be positioned in the aforesaid plane in a circle around the central axis and, further, in the manner of a regular polygon. It is useful in this case for the central axis of the collecting optic to be oriented perpendicular to the plane in which the light sources are arranged. Such a unidirectional arrangement of the light sources in relation to the collimating optics or the collecting optic brings about uniform incoupling of the ray bundles into the collecting optic, and thus advantageously uniform blending of the generated light.

Preferably at least one of the collimating optics of the lighting device comprises, on a side facing the associated light source, a collimating structure that collimates the ray bundle generated by that light source. The term “collimation” is to be understood for the present as meaning reducing the included angle of the ray bundle, it being advantageous for the ray bundle to be parallelized as fully as possible or even completely.

The collimating structure preferably comprises a central, lens-shaped, roughly convexly curved region that is surrounded by a reflector ring or a plurality of reflector rings.

This central lens-shaped region operates to collimate the corresponding central region of the associated ray bundle. This lens-shaped region can be spherically or aspherically curved, although the fullest possible parallelization of the ray bundle in the central region after passage through the entrance surface—i.e., with only one refracting surface—is usually obtained with an aspherical curvature.

The reflector ring or rings serve to collimate the edge region of the ray bundle, i.e. that surrounding the central region, by reflection from at least one reflector surface. The reflector ring is preferably made of a radiation-transparent material and comprises a reflector entrance surface and a reflection surface. The ray bundle is first coupled, in the edge region, through the reflector entrance surface into the reflector ring, and is then reflected by the reflection surface to produce collimation or even parallelization of the ray bundle. The reflection surfaces are preferably configured as totally reflecting surfaces.

Such conformation of the collimating structure has the advantage of permitting the collimation even of sharply divergent ray bundles, while at the same time keeping the design height and thus the volume of the collimating optic to a minimum. In addition, with suitable shaping and suitable mutual orientation of the lens-shaped central region and the reflector ring, the ray bundle concerned is parallelized immediately after passing through the entrance surface of the central region or the reflection surface(s). The extraction side of the collimating optic is therefore available for other optical functions, particularly for deflecting the ray bundle.

In a further configuration of the lighting device, at least one of the collimating optics comprises, on a side facing away from the associated light source, a diffracting structure that directs the ray bundle generated by the associated light source to the entrance side of the collecting optic. This diffracting structure is preferably configured as a prism structure. Such a prism structure comprises a plurality of refracting or reflecting surfaces that are aligned with each other and are preferably arranged in parallel. The reflecting surfaces can be configured as totally reflecting.

Particularly in the case of a parallelized ray bundle, such a prism structure permits well-defined and uniform diffraction of the ray bundle in the direction of the entrance surface of the collecting optic.

In a preferred improvement of the lighting device, the collecting optic comprises a prism structure, a pyramid structure or a cone structure on the entrance side. These structures can be adapted to and aligned with the collimating optic such that the optical losses associated with incoupling into the collecting optic are advantageously kept to a minimum. It has been found in the context of the invention that different structures may be ideal, depending on the number of light sources in the lighting device. A lighting device with exactly two light sources preferably has a collecting optic that has a prism structure on its entrance side, a lighting device with exactly four light sources a collecting optic that has a pyramid structure on its entrance side, and a lighting device with four or more light sources a collecting optic that has a cone structure on its entrance side. In general, an even number of light sources is advantageous in connection with the invention.

In a preferred configuration, LED chips or LED components are used as light sources for the lighting device. In this context, the term “LED component” is to be understood as an optoelectronic component comprising an LED chip or a plurality of LED chips and a component housing, i.e., for example, a component suitable for mounting on a circuit board by a soldering, welding or gluing method.

In the case of a lighting device for mixed-color, particularly white, light, it is feasible to use light sources, for example LED chips or LED components, having different characteristic emission wavelengths. The term “characteristic emission wavelength” is to be understood here as meaning in particular a wavelength that is associated with the light source and is characteristic of the color locus of the radiation emitted by that light source. For example, in the case of an LED used as the light source, this characteristic emission wavelength can be the central wavelength (peak wavelength), the centroid wavelength (centroid of the emission spectrum, assuming spectral equilibration) or the dominant wavelength of the LED.

A lighting device for mixed-color, particularly white, light, preferably comprises at least one light source having a characteristic emission wavelength in the blue region of the spectrum, at least one light source having a characteristic emission wavelength in the green region of the spectrum and at least one light source having a characteristic emission wavelength in the red region of the spectrum. With a lighting device of this kind, the color locus of the mixed-color light can be advantageously be set within broad limits. In the case of a white light source, the white point can advantageously be set precisely.

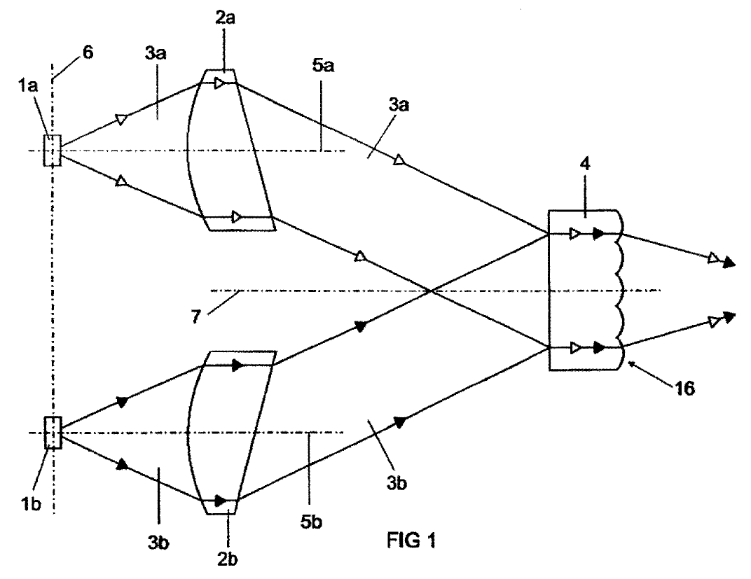

Further features, preferences and suitabilities will emerge from the following description of exemplary embodiments of the lighting device, taken in conjunction with FIGS. 1 to 10.

Therein:

FIG. 1 is a schematic sectional view of a first exemplary embodiment of the lighting device,

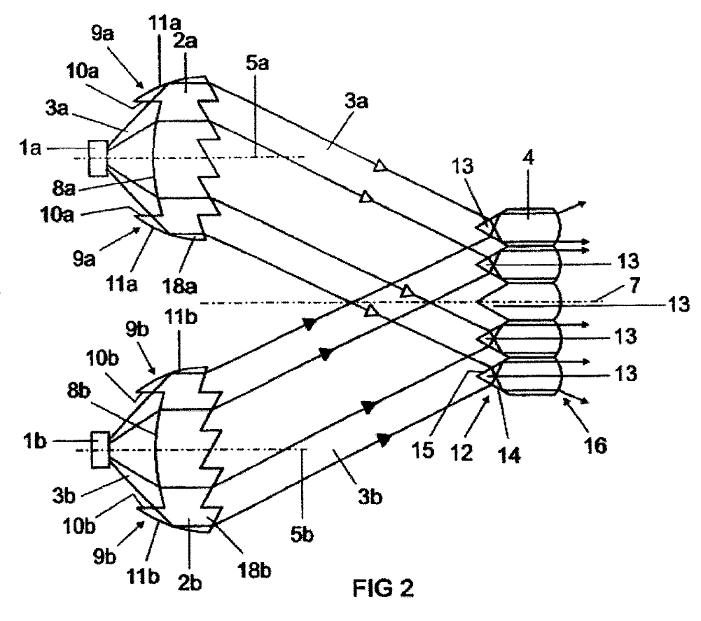

FIG. 2 is a schematic sectional view of a second exemplary embodiment of the lighting device,

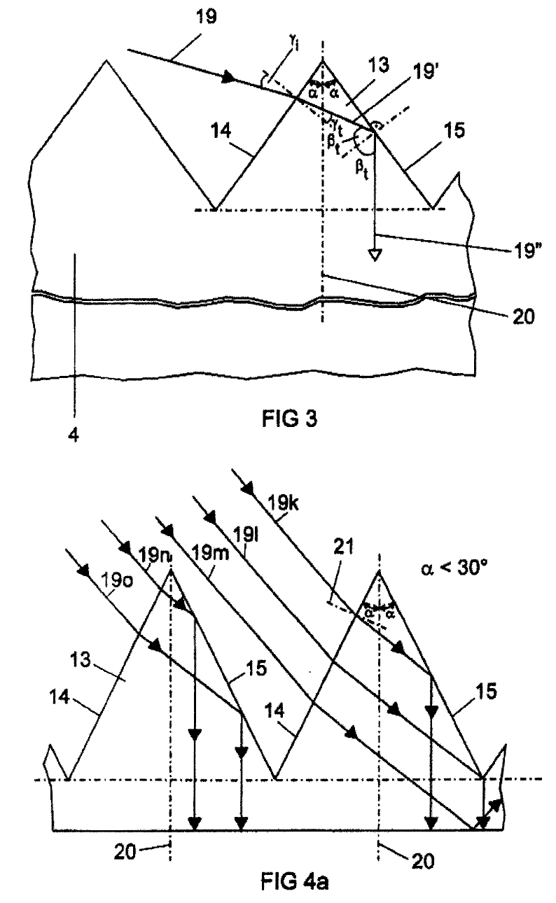

FIG. 3 is a schematic detail view of the second exemplary embodiment of the lighting device,

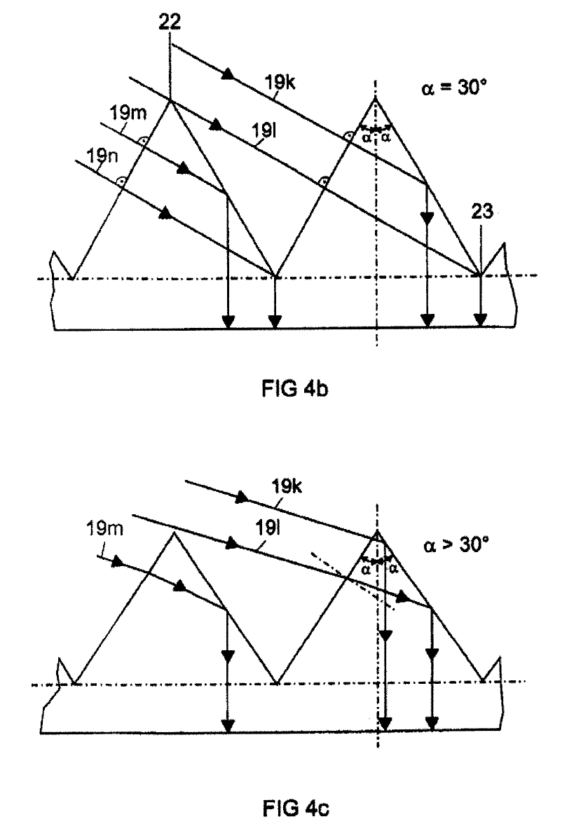

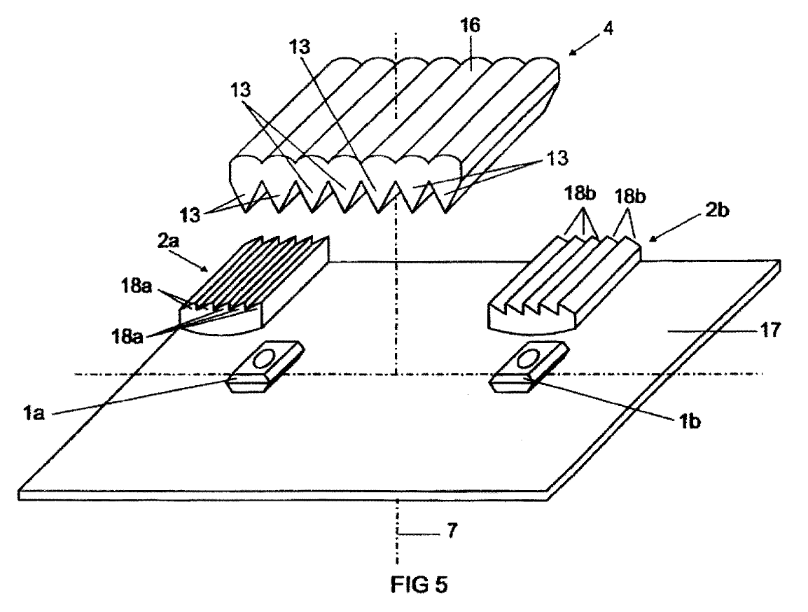

FIGS. 4A, 4B and 4C show three variants of the ray path in a third exemplary embodiment of the lighting device,

FIG. 5 is a schematic perspective view of a fourth exemplary embodiment of the lighting device,

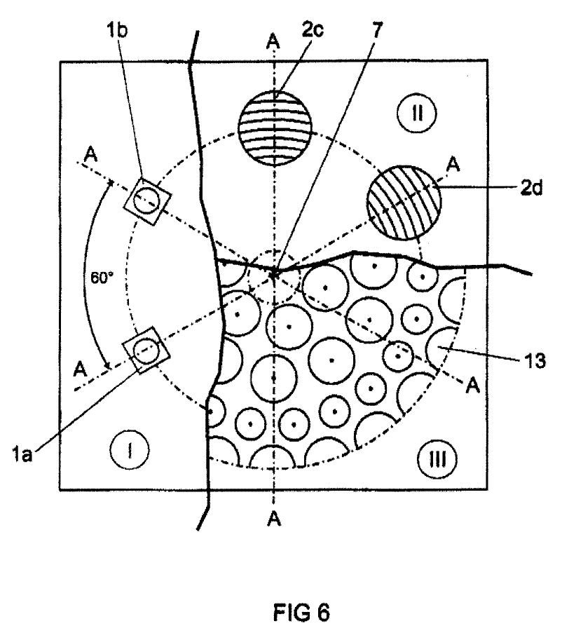

FIG. 6 is a schematic plan view of a fifth exemplary embodiment of the lighting device,

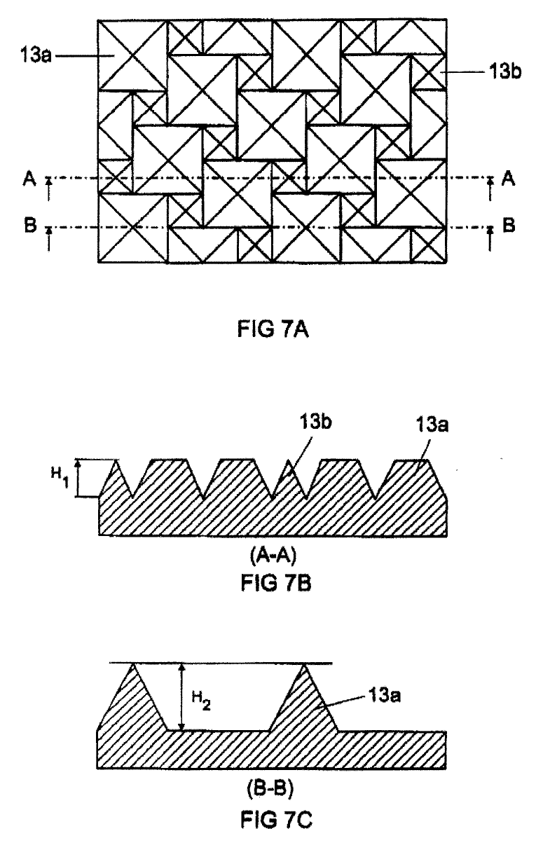

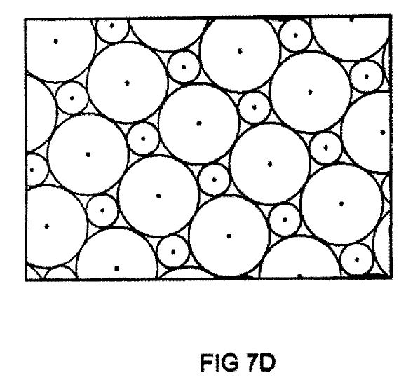

FIGS. 7A, 7B, 7C and 7D are schematic plan views of two variants of a collecting optic for the lighting device and related sectional views,

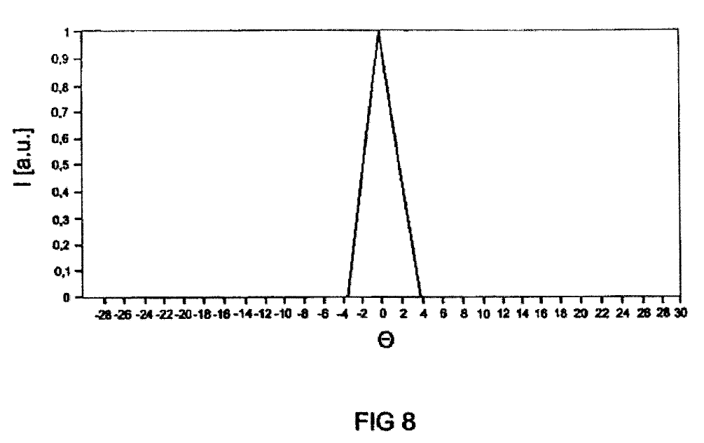

FIG. 8 is a schematic graphic representation of the radiation characteristic of the second exemplary embodiment of the lighting device,

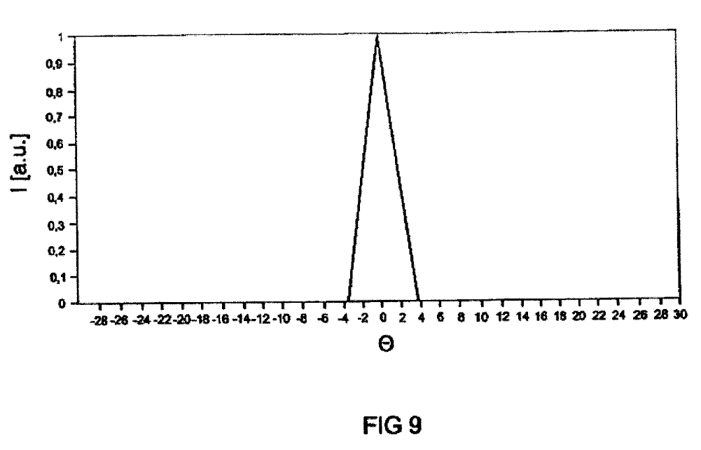

FIG. 9 is a schematic graphic representation of the radiation characteristic of the sixth exemplary embodiment of a lighting device, and

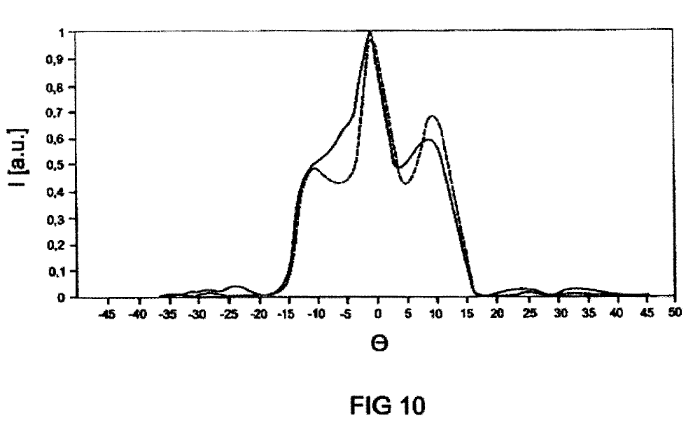

FIG. 10 is a schematic graphic representation of the radiation characteristic of a seventh exemplary embodiment of the lighting device.

Like or like-acting elements are provided with the same reference numerals in the figures.

The first exemplary embodiment of the lighting device, depicted in FIG. 1, comprises two light sources 1a, 1b, which are preferably implemented as LED components.

Each of the light sources 1a, 1b is followed by a collimating optic 2a, 2b. Each collimating optic has a lens-like shape on the entrance side, i.e., the side facing the respective light source 1a, 1b, such that the respective ray bundle 3a, 3b emitted by each light source 1a, 1b is substantially parallelized by the lens-shaped surface of the respective collimating optic 2a, 2b.

The side of the collimating optic 2a, 2b facing away from the respective light source 1a, 1b is configured such that the ray bundle 3a, 3b is directed at the entrance side of a common collecting optic 4. To this end, the entrance surface of each collimating optic 2a, 2b is disposed in a prism- or wedge-like manner obliquely to an axis 5a, 5b associated with one of the collimating optics 2a, 2b and arranged substantially parallel to the main radiation direction of the light source 1a, 1b concerned. The ray bundles 3a, 3b thus are refracted from the exit surfaces of the collimating optics to the common collecting optic 4, said ray bundles 3a, 3b traveling between the respective collimating optic 2a, 2b and the common collecting optic 4 obliquely to the associated main radiation direction or optical axis 5a, 5b.

The radiation from a multiplicity of light sources can advantageously be coupled into a single common collecting optic in this way. Preferably, as illustrated, the light sources1a, 1b are in this case arranged in a plane 6, which in FIG. 1 is perpendicular to the plane of the drawing, and the individual light sources 1a, 1b are further preferably arranged similarly spaced apart from a central axis 7 of the collecting optic 4. The light sources 1a, 1b can thus be arranged, for example, in a circle around the central axis 7, and further in the manner of a regular polygon in the common plane (not shown).

On the entrance side of the common collecting optic 4, the ray bundles 3a, 3b overlap and are preferably coupled into the collecting optic by means of a structuring (not shown) that will be described in more detail below. Ray bundles can in this case be parallelized and/or blended with each other. In addition, the exit side of the collecting optic 4 can be provided with a lens array 16 that can be shaped for example according to a given radiation characteristic of the lighting device.

The second exemplary embodiment of a lighting device, illustrated in FIG. 2, is substantially the same as the first exemplary embodiment in terms of the arrangement of the light sources 1a, 1b of the collimating optics 2a, 2b and the collecting optic 4.

In contrast thereto, the collimating optics 2a, 2b are provided on their respective entrance sides with a collimating structure having a central, lens-shaped, roughly convexly curved region 8a, 8b surrounded by a reflector ring 9a, 9b. A plurality of reflector rings arranged roughly concentrically to the respective optical axis 5a, 5b can also be provided. Such collimating structures are described in more detail in the document WO 02/33449. The content of that document in this regard is hereby incorporated by reference into the present application.

The rays near the axis of the respective ray bundle are collimated or parallelized by this central lens-shaped region of the collimating structure. By contrast, the rays far from the axis, which usually demand disproportionately high refraction in order to be collimated or parallelized, are collimated or parallelized not just by refraction, but also by reflection from the reflector ring. As illustrated in FIG. 2, the rays far from the axis enter the reflector ring 9a, 9b through a lateral face 10a, 10b and are then reflected by an opposite lateral face 11a, 11b such that after being reflected, the ray concerned forms a smaller angle with the optical axis than it did before entering the collimating optic, or even travels parallel to the optical axis 5a, 5b. The reflector ring can be configured as totally reflecting and/or be provided with a reflective coating.

On the exit side, the collimating optics 2a, 2b are each provided with a plurality of lamellar, prismatic projections 18a, 18b, by means of which the ray bundles from the two light sources 1a, 1b are deflected to the common collecting optic. These lamellar, prismatic projections 18a, 18b run substantially perpendicular to the plane defined by the central axis of the collecting optic and a straight line connecting the light sources 1a, 1a.¹
¹ Translator's Note: The last clause actually reads “and a through the [or “by the”] straight line connecting the two light sources.” The words “through the” (durch die) make no sense grammatically and do not appear in the other occurrence of this sentence (p. 13 of this translation, p. 17 of the German).

Configured on the entrance side of the collecting optic 4 is a serrated structuring 12 by means of which the ray bundles 3a, 3b of the various light sources 1a, 1b are parallelized with each other. This structuring 12 comprises a plurality of projections 13, each having two lateral faces 14, 15 arranged at a predefined angle to each other. These projections 13 can, for example, be prismatic, pyramidal or conical in shape.

In deviation from FIG. 2, these projections can also have different heights, as will be explained in more detail in conjunction with FIGS. 7A, 7B, 7C and 7D.

As illustrated, the individual rays of the ray bundles 3a, 3b preferably enter the projections 13 through one of the lateral faces 14 and are then reflected by the lateral face 15 opposite that lateral face 14 in such fashion that after being reflected, the rays concerned form a smaller angle with the central axis 7 of the collecting optic 4 than they did before entering the collecting optic, or even travel parallel to the central axis 7. As in the first exemplary embodiment, the lens array 16 on the exit side of the collecting optic 4 can be used to achieve more thorough blending of the ray bundles 3a, 3b and/or adaptation to a predefined radiation characteristic.

FIG. 3 is a detail view of a preferred ray path through the collecting optic 4 according to the second exemplary embodiment. Here, a ray 19 strikes lateral face 14 of projection 13 at an angle γ₁ (all angles of incidence refer here and hereinafter to the associated normal to the interface), is refracted and enters projection 13 at an angle γₜ.

The angles γᵢ and γₜ are determined by the law of refraction:
sin γᵢ=n sin γ,
where n is the ratio of the refractive index' of the collecting optic to the refractive index of the environment.

This ray 19′ then impinges on the opposite lateral face 15 of projection 13 at an angle βᵢ and is totally reflected there, such that the reflected ray 19″ travels at an angle βₜ to lateral face 15 and parallel to the axis of symmetry 20 of the projection. The axis of symmetry 20 is preferably aligned in parallel with the central axis 7 of the collecting optic 4.

It follows from the law of reflection and the parallelity of the reflected ray 19″ to the axis of symmetry 20 that:
βᵢ=βₜ=α,
where 2α is equal to the angle between the two lateral faces 14 and 15. Angle α will be termed the “included angle” hereinafter.

This yields the following relation for the entrance angle γᵢ:
γᵢ=arc sin [n sin(3α−90°)] (1)

For total reflection to be able to occur at lateral face 15, the angle of incidence βₜ must be greater than the critical angle of total reflection θ_{c}, which is determined by:
θ_{c}=arc sin(1/n).

This yields, as a condition for angle α:
α<90°−arc sin(1/n) (2)

Hence, to obtain a preferred ray path of the kind described in connection with FIG. 3, conditions (1) and (2) must be met. This advantageously results in nearly lossless reflection, since full use is made of total reflection, and causes ray 19″ to be oriented parallel to the axis of symmetry 20 and thus, where applicable, parallel to central axis 7.

A further condition for angle α results from the consideration that the impingement of rays on the extraction surface of the collecting optic without first being reflected by the lateral face 15 opposite lateral face 14 should be prevented insofar as possible.

FIG. 4A shows a detail view, corresponding to FIG. 3, of collecting optic 4 in which a plurality of projections 13, for example in the nature of prisms that are not pyramids, is formed on the entrance side, each of said projections having a lateral face 14 and a lateral face 15 forming an angle 2α between them.

Illustrated by way of example are five parallel rays 19k, 19l, 19m, 19n, 19o of a ray bundle emitted by one of the light sources of the lighting device and collimated by means of the associated collimating optic. Rays 19k, 19l, 19n and 9o each enter the projections 13 through lateral face 14, as in the case of the ray path shown in FIG. 3, and are totally reflected by the opposite lateral face 15 such that the reflected rays travel parallel to the axes of symmetry 20 of the projections.

In contrast to FIG. 3, the included angle α is chosen to be less than 30°, so that rays 19k, 19l, 19m, 19n, 19o form a smaller angle with the axes of symmetry 20 than do the normals 21 of lateral faces 14. This means that rays 19k, 19l, 19m, 19n, 19o impinge on lateral faces 14 “above the normal” 21, whereas in the case of the ray path shown in FIG. 3, the rays 19 strike the lateral faces 14 “below the normal.”

As FIG. 4A shows, if included angle α is small enough, some of the rays, illustrated by way of example as ray 19m, strike the extraction surface immediately after entering projection 13 or collecting optic 4, without first being reflected by lateral face 15. These rays may be reflected by the extraction surface, and in any case are not aligned in parallel with the other rays 19k, 19l, 19n, 19o, which can lead to efficiency losses.

More advantageous in this connection is a ray path of the kind illustrated in FIG. 4C or FIG. 3, where the included angle α is greater than 30°. The impingement of rays 19k, 19l, 19m on the extraction surface without being reflected by lateral faces 15 is eliminated here, since rays 19k, 19l, 19m strike the projections at such a shallow angle that total reflection from lateral face 15 is possible regardless of circumstances.

FIG. 4B shows the boundary case between the ray paths illustrated in FIGS. 4A and 4C; that is, included angle α is 30°. In this case, rays 19k, 19l, 19m, 19n strike lateral face 14 perpendicularly, i.e., at an incident angle of 0°. The boundary ray 191 travels past the apex of one projection and subsequently impinges on the angle 23 between two adjacent projections. Aside from this (idealized) boundary ray 191, all the rays are totally reflected by lateral face 15 and are aligned parallel with the axes of symmetry 20 of the projections.

It follows that in the lighting device, it is advantageous for the projections 13 of the collecting optic to have an included angle α of at least 30°. The same applies if the projections are configured as cone-shaped. For total reflection to be possible with a corresponding angle of incidence on lateral face 15 of 60° (FIG. 4B) or less (FIG. 4C), the refractive index ratio n must be equal to or greater than (sin 60°)⁻¹=1.154 . . . . This condition is met by a great many transparent materials, particularly glasses and plastics, at the interface with air or another gaseous medium.

FIG. 5 is a perspective view of a fourth exemplary embodiment of a lighting device, which is largely the same as the second exemplary embodiment. As in the first and second exemplary embodiments, two light sources 1a, 1b are provided, for instance in the form of LED components. The LED components are mounted on a circuit board 17 that defines the common reference plane 6 of the light sources.

Each of the light sources 1a, 1b is followed, on its light-radiating side, by a respective collimating optic 2a, 2b. The collimating optics 2a, 2b collimate or parallelize the ray bundles 3a, 3b emitted by the light sources, and on the exit side direct them to a common collecting optic 4. On their respective entrance sides, collimating optics 2a, 2b can be configured as lens-shaped or can be provided with a collimating structure of the kind used in the second exemplary embodiment (not shown).

On the exit side, collimating optics 2a, 2b each comprise a plurality of lamellar, prismatic projections 18a, 18b by which the ray bundles from the two light sources 1a, 1b are deflected to the common collecting optic. These lamellar prismatic projections 18 run substantially perpendicular to the plane defined by the central axis of the collecting optic and a straight line connecting the light sources.

As in the second exemplary embodiment, the collecting optic 4 has on its entrance side a structuring comprising a plurality of projections 13 operative to parallelize the ray bundles emitted by the two light sources. The projections are each prismatically configured and extend in the same direction, preferably substantially perpendicular to the plane defined by the central axis of the collecting optic and a straight line connecting the light sources.

FIG. 6 is a plan view of a fifth exemplary embodiment of a lighting device. This exemplary embodiment is substantially the same as the previous exemplary embodiments in terms of the configuration of the collimating optics and the collecting optic.

In contrast thereto, in the fifth exemplary embodiment, six light sources—only two of which are visibly represented (1a, 1b)—are provided, for example in the form of LED chips or LED components mounted on a common circuit board on a first plane I. The light sources 1a, 1b are arranged equidistantly from the central axis 7 of the collecting optic 4, i.e. in a circle around central axis 7, and further in the manner of a regular hexagon, spaced 60° apart on the axes A.

Each of the six light sources 1a, 1b is followed, in a plane II lying thereabove, by a collimating optic—only two (2c, 2d) of which are shown in the partial section of plane II—which collimates the ray bundle from its respective one of the six individual light sources 1a, 1b and directs it, via an exit-side prism structure located in plane III thereabove, to the entrance side of the collecting optic 4.

These exit-side prism structures of the collimating optics do not include any projections that are exactly prismatic. Rather, these projections are slightly curved and are arranged concentrically to produce an effect of focusing on the central axis 7. Such projections, which are not prisms in the mathematical sense, but partial solids of revolution generated by rotating a polygon about a fixed axis, are also considered to be prismatic in the context of the invention.

The entrance side of the collecting optic 4 comprises a multiplicity of conical projections, such that the rays of the individual ray bundles approximately enter a conical projection on one side and are totally reflected on the opposite side of the cone. This total reflection occurs in such a way that the reflected ray travels approximately parallel to the central axis 7.

A lighting device emitting mixed-color, for example white, light preferably has as its light sources LED chips or LED components with different characteristic emission wavelengths. For example, in the case of two light sources, one light source can emit blue light and the other yellow-orange light, with the collecting optic uniformly blending the blue and yellow-orange light to produce white light.

In the case of three or more light sources, at least one of the light sources preferably emits red light, another light source emits green light and another light source blue light, which again are blended uniformly by the collecting optic to yield white light.

FIG. 7A is a plan view of a first variant of a collecting optic for a lighting device. FIGS. 7B and 7C illustrate related sectional views along lines A-A and B-B, respectively.

In contrast to the previously described exemplary embodiments, here the collecting optic comprises on its entrance side a plurality of pyramidal projections 13a and 13b, which in this case have different heights H₁ and H₂. In addition, it may be advantageous for the pyramidal projections to be arranged, not in a matrix-like manner, but offset from one another, as shown.

This configuration prevents the formation of grid- or lattice-like recesses in the collimating structure that would be detrimental to the desired guidance of the rays.

FIG. 7D is a plan view of a second variant of a collecting optic for a lighting device. In contrast to the first variant, here the entrance-side projections are configured as conical. The cones have different heights and are arranged offset from one another.

FIG. 8 schematically illustrates the radiation characteristic of the second exemplary embodiment illustrated in FIG. 2, i.e. a collecting optic 4 with prism-shaped projections 13 in combination with two light sources. The graph shows the radiated intensity I, in arbitrary units, plotted against the radiation angle θ relative to the central axis 6 of the collecting optic 4. As a simulation calculation shows, about 89% of the light generated by the light sources is emitted within an angle of ±3°, resulting in very good collimation combined with uniform mixing of the ray bundles generated by the individual light sources.

FIG. 9, correspondingly, shows the radiation characteristic of a further exemplary embodiment of a lighting device, in which, in contrast to the second exemplary embodiment, four light sources and pyramid-shaped projections are provided. As a corresponding simulation calculation shows, about 70% of the light generated by the light sources is emitted within an angle of ±3°, resulting in good collimation combined with uniform mixing of the ray bundles generated by the individual light sources and an increase in the number of light sources.

FIG. 10 schematically represents the radiation characteristic of a further exemplary embodiment of a lighting device, in which, in contrast to the second exemplary embodiment, four light sources and cone-shaped projections are provided. As a corresponding simulation calculation shows, about 42% of the light generated by the light sources is emitted within an angle of ±16°, resulting in adequate collimation combined with uniform mixing of the ray bundles generated by the individual light sources. In this exemplary embodiment, additional light sources can advantageously be added without further measures. Due to the rotational symmetry of the conical projections, it is in particular unnecessary to separately align the additional light sources with the projections of the collecting optic.

The explanation of the invention is not limited to the described exemplary embodiments. Rather, the invention encompasses the features disclosed in the claims and the description and all combinations of those features, even if that combination is not the subject matter of an individual claim.

In addition, it is understood that geometrical terms such as “perpendicular” or “parallel” represent a mathematical idealization that can only be approximated in reality. A deviation of about 5° to 10° from exact parallelity or orthogonality is negligible, as a rule, and is encompassed by the terms “parallel” and “perpendicular” in the context of the present invention.

1. A lighting device comprising a plurality of light sources, each of which produces a respective ray bundle and has associated with it a respective collimating optic, and comprising a collecting optic having an entrance side and an exit side, wherein said collimating optics direct the ray bundles of the respective associated said light sources to the entrance side of said collecting optic, and said ray bundles are extracted collectively on the exit side.

2. The lighting device as in claim 1, wherein at least one of said light sources has a main radiation direction associated with it, and the ray bundle from said light source is directed by said collimating optic to the entrance side of said collecting optic in a direction oblique to said main radiation direction.

3. The lighting device as in claim 2, wherein each said light source has a main radiation direction associated with it, and the respective said ray bundle generated by each of said light sources is directed by the respective said collimating optic to the entrance side of said collecting optic in a direction oblique to the respective said main radiation direction.

4. The lighting device as in claim 1, wherein
said ray bundles overlap on the entrance side of said collecting optic.

5. The lighting device as in claim 1, wherein
said light sources are arranged in a common plane.

6. The lighting device as in claim 5, wherein said collimating optics are arranged spaced apart from said plane.

7. The lighting device as in claim 1, wherein
said collecting optic has a central axis associated with it, and said light sources are arranged similarly spaced apart from said central axis.

8. The lighting device as in claim 1, wherein
at least one collimating optic comprises, on a side facing the associated said light source, a collimating structure that collimates said ray bundle generated by the associated said light source.

9. The lighting device as in one of the preceding claims, wherein
at least one of said collimating optics comprises, on a side facing away from the associated said light source, a deflecting structure by which said ray bundle generated by the associated said light source is directed to the entrance side of said collecting optic.

10. The lighting device as in claim 9, wherein said deflecting structure comprises a plurality of prisms.

11. The lighting device as in claim 1, wherein said collimating optics are each configured in one piece.

12. The lighting device as in claim 1, wherein
said collecting optic comprises a prism structure, a pyramid structure or a cone structure on its entrance side.

13. The lighting device as in claim 12, wherein
said lighting device comprises exactly two light sources and said collecting optic comprises a prism structure on its entrance side.

14. The lighting device as in claim 12, wherein
said lighting device comprises exactly four light sources and said collecting optic comprises a prism structure on its entrance side.

15. The lighting device as in claim 12, wherein
said lighting device comprises more than four light sources and said collecting optic comprises a cone structure on its entrance side.

16. The lighting device as in claim 12, wherein
said prism, pyramid or cone structure has a plurality of light entrance surfaces and/or reflection surfaces, which are arranged at least in part so as to enable said ray bundles to be parallelized with one another by refraction and/or reflection.

17. The lighting device as in claim 1, wherein
said light sources are LED chips or LED components.

18. The lighting device as in claim 1, wherein
each said light source has associated with it a characteristic emission wavelength, and the emission wavelengths of at least two of said light sources are different from each other.

19. The lighting device as in claim 18, wherein
said lighting device comprises at least one light source having a characteristic emission wavelength in the blue region of the spectrum, at least one light source having a characteristic emission wavelength in the green region of the spectrum and at least one light source having a characteristic emission wavelength in the red region of the spectrum.

20. The lighting device as in claim 19, wherein
the ray bundles extracted from the exit side of said collecting optic create the impression of white light.

21. The lighting device as in claim 1, wherein
said collecting optic blends the said ray bundles emitted by said light sources.

22. The lighting device as in claim 1, wherein
said collecting optic comprises a lens structure on its exit side.

23. The lighting device as in claim 21, wherein said collecting optic comprises a lens array on its exit side.
